(19) United States
(12) Patent Application Publication
(10) Pub. No.: US 2015/0070877 A1
(43) Pub. Date: Mar. 12, 2015

(54) Illuminated Mobility Enhancing Device

(71) Applicant: TECHNICAL VISION, INC., Elkins Park, PA (US)

(72) Inventors: Audrey Smith, Elkins Park, PA (US); Kenneth Ayer, Elkins Park, PA (US); Lorraine Keller, Elkins Park, PA (US)

(21) Appl. No.: 14/358,649

(22) PCT Filed: Dec. 11, 2012
(86) PCT No.: PCT/US2012/068970

§ 371 Date: May 15, 2014

Related U.S. Application Data
(60) Provisional application No. 61/569,253, filed on Dec. 11, 2011.

(51) Int. Cl. A45B 3/04; A61H 3/00; F21V 33/00; F21V 23/04; F21V 15/01

(52) U.S. Cl. CPC A45B 3/04; F21V 23/04; F21V 15/012; F21V 33/0004; A61H 3/00; F21Y 2101/02
USPC 362/102

(57) ABSTRACT

The present invention provides a mobility enhancing device having means for electronically illuminating a travel path, which means comprises a housing, the housing containing an illumination source of an intensity range suitable for illumination of a travel path and of an optimal wavelength spectrum, the illumination being directed at such an angle downward and not forward, so as not to impair the vision of non-users of the device and to minimize glare from the illumination source that can interfere with the vision of the user. In a preferred embodiment, a mobility enhancing device such as a walking cane is provided including means to electronically illuminate a travel path to detect obstacles. In a further preferred embodiment, a long cane such as that typically used by the blind and visually impaired is improved in accordance with the invention.

### REFERENCE TO RELATED APPLICATION

This application is a non-provisional application, which incorporates by reference herein, and claims priority, in part, of U.S. Provisional Application No. 61/569,253, filed Dec. 11, 2011.

### BACKGROUND OF THE INVENTION

People with limited vision have made great strides in education, employment, and information access, but unfortunately have not benefitted from any significant breakthroughs in practical and affordable assistive devices that facilitate safe and independent travel outside of the home. Blind and low vision travelers may become very adept at negotiating a travel route with the traditional long cane; however even when successfully employed, ground-level obstacle detection is limited to an area two feet or less ahead of the traveler's foot and may not allow enough time for the user to perceive and take appropriate action to avoid tripping or falling on hazards such as stairs, curbs, potholes, tree roots and broken sidewalks. In a mobility context, the ability to view objects from a distance enables anticipation, for example the ability to preview the travel path provides the traveler with the ability to be proactive through the identification and avoidance of obstacles such as curbs or stairs before arriving at them. Of all the senses, vision provides the traveler with the means to use an anticipatory, proactive style of mobility that is characterized by quickly and easily obtaining and processing critical information at various distances. There is a need for assistive mobility devices that enhance vision to maximize the time and ability to perceive objects and hazards in the travel path. A recent multinational survey, (Hersh M. and Johnson M., 2010, A Robotic Guide for Blind People, Part 1, A Multi-national Survey of the Attitudes, Requirements and Preferences of Potential End-Users, Applied Bionics and Biomechanics 7(4): 277-288), confirmed that the blind and visually impaired have strong interest in “robotic guides”, also referred to Electronic Travel Aids, that perform a number of different orientation and mobility functions under a wide range of circumstances. Survey respondents very clearly want devices that are discreet and inconspicuous so that the user does not “stand out”. They also want assistive devices that are affordable, small, lightweight and portable, easy to use, long product life, robust to damage, require minimal maintenance and have long battery life.

The number of people experiencing age-related vision and mobility problems is rapidly increasing globally. Vision loss is caused by many conditions, including macular degeneration, glaucoma, retinitis pigmentosa and cataracts, which in turn lead to loss of independence and increased safety risks due to mobility limitations. As the number of people with visual and physical restrictions increases, so does the need for new and better assistive travel aids to maintain safety, independence, active lifestyle and good quality of life. The visually impaired, or low vision population, comprises people with visual acuity ≦20/40 or reduced visual field or severely reduced contrast sensitivity or visual field that interferes with everyday activities. Typically, these conditions cannot be corrected with medicine, corrective lenses or surgery. People with these visual limitations fall within the continuum between fully sighted and legally blind. People with low vision experience fluctuation in the quality and clarity of what they see due to medical conditions (e.g., advanced retinitis pigmentosa, advanced glaucoma, wet age-related macular degeneration) and in particular external conditions such as changes in environmental lighting or contrast. These conditions interfere with interpretation and negotiation of ground-level hazards (Geruschat D. and Smith A J., 2010, Low Vision for Orientation and Mobility. Also see Chapter 3 in Foundations of Orientation and Mobility, Volume 1, 3^{rd} Edition. AFB Press, New York). Geruschat and Smith identify four major and consistent problems encountered by low vision travelers: 1) managing light (too much/too little, light adaptation); 2) detecting changes in terrain and elevation; 3) reducing unwanted contact with obstacles; and 4) negotiating street crossings. Navigation by travelers with low vision can be greatly improved with the use of an assistive mobility device, also referred to as an Electronic Travel Aid (ETA) that facilitates detection and avoidance of ground-level features, freeing the traveler to concentrate on object identification, orientation, and viewing greater distances.

In particular, while in general low vision users can derive safety benefits from the use of a long cane, many do not use a long cane in order to avoid making their low vision condition known to others. For some low vision travelers, an assistive device may only be needed in certain conditions where vision is most limited. For example, some users may only need assistance during evening or night travel, or in unfamiliar areas, in particular under conditions of low or fluctuating light. Thus, there is also a need for enhancements to the traditional long cane that provide beneficial features to low vision users to encourage wider adoption for safer, more confident and independent travel.

Various types and configurations of travel assist devices have been heretofore described in the art. For example, U.S. Published Patent Application No. US 2011/0030748 discloses an adjustable lighted walking aid adapted to be used in low light or dark areas including a cane having a front light for illuminating obstacles being encountered in front of the user and a back light for simultaneously illuminating the area proximate the feet of the user so that the user may see and thus help avoid upcoming obstacles in front, as well as observe the area at his or her feet while walking. Other art discloses various walking aids with lights to assist the user in viewing the obstacles and hopefully to avoid tripping and falling. For example, reference may be made to the following U.S. patents: U.S. Pat. Nos. 3,336,469; 4,562,850; 5,197,501; 5,351,704; 5,810,466; 6,463,947; and 4,562,850. Still other approaches are described, for example as in U.S. Pat. No. 5,197,501, which discloses a cane having a moveably mounted light disposed on the outside of the middle section of the cane for allowing the light to be rotated in various directions, and those described in U.S. Pat. Nos. 5,810,466 and 6,463,947.

In addition, there are auditory and other sensory systems such as that described in U.S. Published Patent Application No. US 2006/0028544, which discloses an electronic blind guidance cane comprised of a handle, a cane member, an electric eye system, and a cordless earphone. The handle body consists of a hollow enclosure and a cover, the enclosure capable of containing the electric eye sensing system which consists of a printed circuit board as well as solid sensing electric eyes, a liquid sensing electric eye, a power switch, a battery, and a vibration inductor wired to it. The system is said to be capable of prompting the output of a warning sound or vibration whenever a solid or a liquid obstruction is encountered within a zone of safety to thereby facilitate the distinguishing of the obstruction.

U.S. Pat. No. 7,784,749 discloses an adjustable lighted walking aid said to be adapted to be used in low light or dark areas which may include a cane having a front light for illuminating obstacles being encountered in front of the user and a back light for simultaneously illuminating the area proximate the feet of the user, and is further said to be adjustable in its length to accommodate a variety of users.

In disclosing what is believed to be background art in this section, no admission is made or should be inferred that such background art disclosed in this section legally constitutes prior art.

### SUMMARY OF THE INVENTION

The present invention provides a mobility enhancing device, such as a long cane, a walking cane, a support cane, a walking stick, or the like, having means for electronically illuminating a travel path, which means comprises a housing, the housing containing an illumination source of an intensity range suitable for illumination of a travel path and of an optimal wavelength spectrum, the illumination being directed at such an angle downward and not forward, so as not to impair the vision of non-users of the device and to minimize glare from the illumination source that can interfere with the vision of the user.

In a preferred embodiment in accordance with the present invention, a mobility enhancing device is provided including means to electronically illuminate a travel path to detect obstacles. In a further preferred embodiment, a long cane such as that typically used by the blind and visually impaired is improved in accordance with the invention, by providing a travel path illuminating device which comprises: a housing mounted to a device such as a long cane, white cane, walking cane, or other walking aid, the housing containing a non-detachable illumination source of an intensity range suitable for illumination of a travel path and of an optimal wavelength spectrum, the illumination beam being preferably directed at such an angle downward and not forward, so as not to impair the vision of oncoming drivers and pedestrians and also to minimize glare from the light source that can interfere with the user's own vision, and further preferably positioned in a single segment of the device. In an especially preferred embodiment the cane shaft is collapsible and is a long or walking/support cane.

### BRIEF DESCRIPTION OF THE DRAWINGS

FIG. 1 shows a preferred embodiment of an illuminated mobility enhancing cane produced in accordance with the present invention.

FIG. 2 shows another preferred embodiment of an illuminated mobility enhancing cane produced in accordance with the present invention.

FIG. 3 shows one preferred example of control circuitry in a preferred embodiment of the invention.

### DETAILED DESCRIPTION OF PREFERRED EMBODIMENTS OF THE INVENTION

In one aspect which is a preferred embodiment of the invention, lighting, preferably in the form of one or more light emitting diodes (LED) is integrated into the traditional long cane used by the visually impaired (blind, legally blind, low vision) such that the lighting will enable the user to perceive and anticipate obstacles and hazards while traveling in areas of extreme visual impairment, for example evening/night outdoor locations or indoor locations with low or no light or conditions where the user moves suddenly from an adequately lighted area to an area of low light where the traveler can suddenly lose all vision. The lighting serves to illuminate the ground in front of and to the sides of the cane and user, for example to visualize ground-level hazards (holes, curbs, steps, ramps) or ground-level safety features such as crosswalks and painted or marked floors or grounds. The perceived area, for example, can extend from the cane tip to about 15-20 feet ahead of the traveler.

Because some low vision users only need the long cane under low light or high contrast conditions, in another aspect of the present invention which is a preferred embodiment the cane is foldable so that it can be stowed or easily carried when not in use. Optionally, lighting is incorporated to illuminate the forward space in front of the user at waist/chest height, for example to locate doorways, door knobs/locks, handles, or to facilitate visualization of any items in front of the user not readily seen without supplemental lighting.

Traditional “walking canes” may include some that are outfitted with built-in or detachable lighting, in particular warning lights that are intended to make the user more visible to others, but not intended to provide light of sufficient intensity for navigation by low vision travelers. However the concept of lighting as an assistive feature on a long cane rather than a warning mechanism is novel and is a particular feature and advantage of the present invention. For example, there are attachable white cane tips with red warning lights, but no white canes on the market with light-guidance systems built in, possibly because it seems counterintuitive to outfit a cane for the blind with lights.

### Light Sources Appropriate for Enhancing Low Vision Travel

Essentially, since rods in the eye are not involved in color perception, they are responsive to all wavelengths and are very sensitive to even very low levels (single photons). Accordingly, in the development of the present invention, it has been discovered that in dark conditions where color perception is not important, white light is advantageous for improvement of almost any visual disease condition. It is believed that it may be necessary to achieve sufficient intensity of light to fire enough rods to improve vision in dark environments. The exception is retinitis pigmentosa, where rods degenerate, and one of the first symptoms and the most problematic disability is night blindness. For example, reference can be made to http://www.provisu.ch/PROVISU/Structure/C11.270.684_en.html. These are patients who can see adequately during the day because they still have cone function, at least until the disease substantially progresses. Such patients do not fare well when going from dark to light (glare) and light to dark (blindness) as their cones take a while to acclimate to change. Interestingly, there are three types of cone cells, L-long wavelength sensitive, M-mid-wavelength sensitive and S-short wavelength sensitive. It may be worthwhile to investigate wavelengths for RP patients that maximize function of cones that are active in mesoptic/scotopic conditions (L and/or M).

In some preferred embodiments, the present invention can include a bracket mounted on a cane to slide thereupon a small light source with batteries, switches, bulbs and circuits, all contained in a single unit. Batteries and switches at top of the cane are in the handle, and the light unit is located in a lower position on the cane.

Other embodiments all within the scope of the present invention can include, but are not limited to: support canes for aging rehabilitation, occupational therapy, physical therapy, walking canes for general outdoor use and hiking and cane-like devices for search and rescue such as avalanche poles. Compositions of such devices can include wood, plastic, metals, fiberglass, upscale aesthetic designs, colors, finishes, and many other materials.

One basic principle of preferred embodiments of the invention is to provide lighting levels above “Civil Twilight” to a visually impaired/disabled person directly in front of their travel path. There are a multiple of disabilities that this invention can benefit, and the safety and quality of life advantages are considerable. In testing of a prototype circuit used in a preferred embodiment of the invention, the device was able to illuminate to such a lux level, and additionally up to between 5 and 10 lux depending on the LED device employed. In the development of the invention, it has been discovered that different color lighting (specifically Red and Green) are effective augmentation to different fields of view based on utilization of Rods and Cones within the eye. Specific diseases of either type of sensory sight cells can benefit from added illumination of those wavelengths. However, to be beneficial to the widest array of users, including senior citizens, generally “white” LED lighting, that is, by the use of LEDs emitting in the visible spectrum of white light, has been found to be particularly preferred, with the preservation of the color variants to benefit subsets of visually disabilities.

In a particularly preferred embodiment of the present invention, approximately 50% of the “Light” is configured to be within 36″ in front of the cane tip, however in testing prototypes of devices of the invention it has been unexpectedly discovered that even the fringe lighting, focused forward, assisted the test subjects in maintaining a reasonable walking pace, as described infra. The test subjects reported being able to see curbs and islands across a street, which was very helpful in navigation.

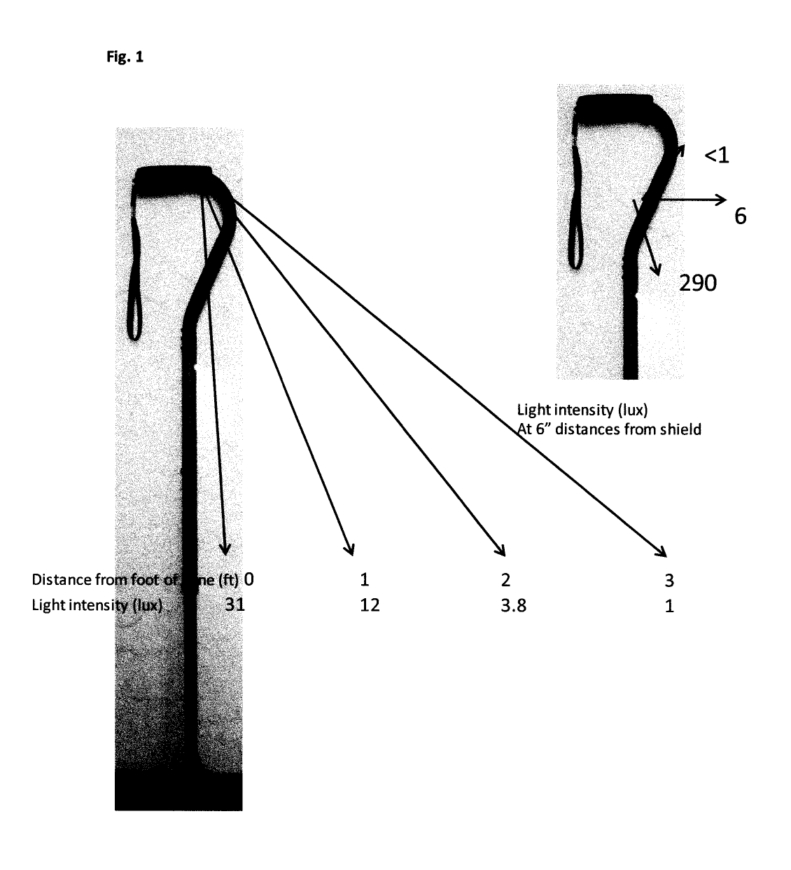

In a preferred embodiment, a device according to the invention can be seen illustrated in FIG. 1, wherein all electronics associated with operation of the device are incorporated into an appropriate segment of a collapsible cane. In an optional feature of a further preferred embodiment, a complementary bracket (not shown) can be attached onto an external light source, which when attached to the cane shaft contains a hood and functions to shield oncoming cars, pedestrians and others from direct exposure to the light source.

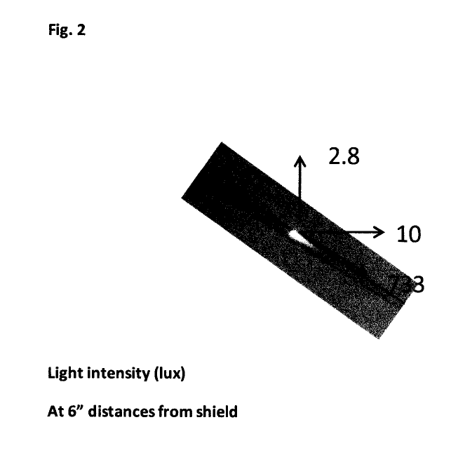

In yet another preferred embodiment of the invention, illustrated in FIG. 2, the light housing is permanently installed into the cane shaft with an opening at the back to add new batteries. The light device itself contains all electronics used in connection with this embodiment. A hood means functions to further direct light down to the base of the cane shaft and to shield the user, pedestrians and oncoming cars from direct light exposure.

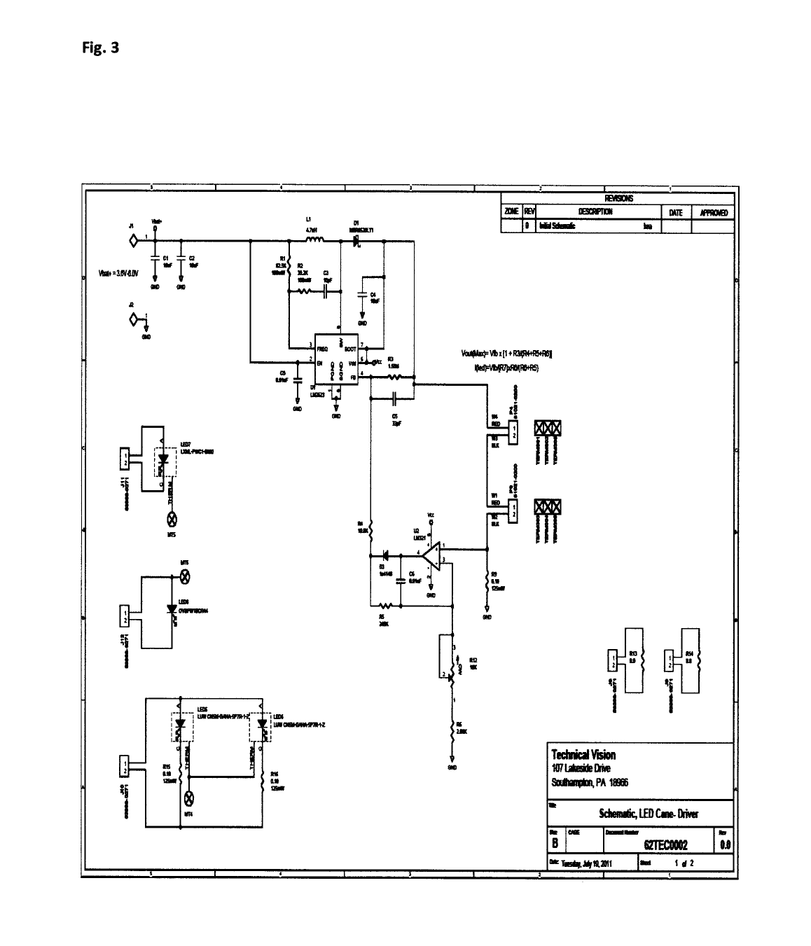

Referring now to FIG. 3, one preferred example of control circuitry in a preferred embodiment of the invention is illustrated for purposes of example, however, one skilled in the art can readily determine that the invention is not limited to the control circuitry specifically described, but that there are many other possible configurations of such circuitry that would be suitable for use in the invention.

In the schematic illustrated in FIG. 3, the following are indicated:

1—Power Supply, which can be any portable source of power storage (i.e. battery), including charging mechanisms.

2—Power regulation and conditioning, used to change the supplied power into a useful voltage and current level to drive the Light Emitting source and the desired light output level.
a. In this case, an adjustable “Constant Current” supply is shown
b. Other “standard” methods of power regulation include “Constant Voltage” and

“PWM” drive among others can be used.

3—Light Output—Semiconductor LEDs used to generate light. This also should include any lenses, reflectors, hoods and baffles that will be employed.
a. Lenses can be used to focus and shape the beam of light.
b. Lenses can be used to change the color spectrum to benefit specific poor vision conditions
c. There are also the functions of glare reduction, and eliminating the beam of horizontal as not to create visual distraction to other persons (drivers, pedestrians)

4—In the schematic, 3 alternate LEDs are identified; however, it is to be appreciated that many conventional LEDs can be used, and that the market is very large and color, lux level and radiation pattern should not therefor be limited in a device produced in accordance with the invention.

Other aspects of a preferred device in accordance with the invention may include, but not be limited to:

1—Pushbutton accessory light

2—Pushbutton “High beam”

3—Photo sensitivity to increase light output as needed.

4—X-Y-Z axis detection to change light level depending on cane orientation
a. Standard cane angle of 50 degrees would illuminate normal
b. If the cane is held (falls) horizontal, the light level would reduce, minimizing chance of unwanted glare or “beam projection”

The following examples are provided to illustrate the advantages of a mobility device produced in accordance with the present invention, and are intended in no way to be limitative of the scope of the invention.

### Example 1

Two subjects were provided with prototype long canes produced in accordance with preferred embodiments of the present invention, and asked to walk the walking course as illustrated in the graphical representation, below. The walking course was in the area of a streetlight as direct illumination, and walking direction is indicated by the arrows.

Two types of LED lights were used on the canes, one spectrally more blue than yellow. It was discovered that the warmer, yellow LED (used on cane #1 as described below) produced better overall results in terms of enhanced vision, by comparison with the blue LED. The users found that a device of the invention with brighter, blue-tinted LED lights, in comparison to the yellow, warmer LED lights, induced substantial glare and did not offer as much of a preview of the surrounding environment as the warmer, yellow light. The subjects engaged in walking on city streets where lighting conditions varied from strong illumination from a streetlight to weak/no illumination, on the walking course illustrated. The subjects used simulators to evaluate the effects of changing conditions of illumination, from full streetlight illumination to almost complete darkness (ambient night light plus occasional interior house lights) on ability to perceive obstacles (curbs, sidewalks), perceive and use shoreline features, perceive curb depths under conditions of reduced visual acuity (20/800) and reduced visual field (10 degrees remaining central field). The subjects compared travel with non-lighted prototype canes with lighted prototype canes in accordance with the invention, with rolling marshmallow tips. The results are summarized below:

Device: Cane #1: 52″ with warmer, yellow light, (Optek OVSPW1BCR44 LED), driven at an actual measurement taken on the street of 11 Lx.
Test condition 1: simulated 20/800 vision reduced acuity

Increased preview, could see twice as far ahead

Increased shoreline and contrast detection

Increased ability to detect objects above waist level (could detect branches overhanging sidewalk at location E)

Ability to see puddles of water and raised (uneven) sections of sidewalks

Increased comfort when walking Subject 1, who was a more proficient long-cane user, was able to travel at a normal pace and Subject 2, who was less proficient, at a moderate pace.

Both Subjects saw both curbs sooner, approximately 20 feet away at locations C, D (the opposite curb was visible from center of the street with illumination, not visible without illumination)

Subject 1 experienced enhanced depth perception at curbs and was able to determine the depth of the curb drop-off with assistive illumination.

Fire hydrant was visible with illumination

Increased driver awareness of pedestrians; drivers slowed down when approaching the light sources

Test Condition 2: simulated 10 degrees remaining central field

Similar observations were made as in Test Condition 1, above, when visual field was reduced.

### Description of Walking Course:

A suburban neighborhood, low traffic flow, very humid, very hazy night-time conditions from approximately 9 pm-11 pm, summer, is utilized. The capital letters that follow designate various waypoints in the course. A: Start of walking course, curbed intersection illuminated by street light (“full illumination”). A to B: Section of sidewalk with direct illumination from street light.

There is a grass strip, approximately 2 feet wide, between the sidewalk and curb. B to C: Sudden transition to dark sidewalk area with no direct illumination from street light. C to D: Street crossing with continuous curb at D, opposite side of street. E: Section of sidewalk with partial illumination from street light, hedge branches overhanging˜1 foot over sidewalk on residential side. D to F: Transition to directly-lighted curb area at F. F-G: Transition from direct illumination to darkness (no street light illumination). G-H: Darkest section of course. H-I: Street crossing, curb on opposite side, no direct streetlight illumination. J: silver fire hydrant. I-K: Transition from no direct streetlight illumination to “full” streetlight illumination, including curb and street crossing under illumination to return to start of the walking course.

### Example 2

In order to demonstrate the advantages of the present invention while in use, observations were obtained from two test subjects who walked a night-time course with a support cane that had been constructed in accordance with a preferred embodiment of the present invention and in configurations thereof with, and without, an LED light source. Walking at night with a vision simulator simulating 20/800 vision, with and without LED illumination mounted on the support (orthopedic) cane, quantitative data was obtained and the results recorded with and without light as to the number of strides or feet that the object was first seen by the subject prior to the test subject reaching an object, and were found to be comparable regardless of which light source was used.

Referring to the graphical illustration below, which is a Google Maps representation of the test course area, the test subjects walked a course on the sidewalk along the south side of Nash Street, beginning approximately half way between Evans Lane and Quigley Avenue. Subjects walked to the intersection of Nash Street and Quigley Avenue and crossed to the north side of Nash Street and along that sidewalk until they were on the opposite side of Nash Street from the starting point. Subjects crossed from the North side of Nash Street to the South side of Nash Street to end at the starting point. Streetlight illumination was present at the intersection of Nash St. and Quigley Avenue. At all other locations, there was essentially no street light illumination and occasional lighting from home interiors or outside entryway lights. The north and south Nash St sidewalks were flanked by grass and/or curbs. As typical of a suburban neighborhood, there were parked cars, shrubs, trees, signposts and poles adjacent to the sidewalk; some of these features were in the sidewalk (hydrant, signs, utility poles), others adjacent but overhanging the edge of the sidewalk (shrubs, fallen branches). Subjects continuously reported what they saw (or didn't see) and distance at which objects or street features were first observed. Their observations were recorded by a second person observer.

Subject 1, walked course with cane, no LED light on cane: Subject bumped into bush 1 that protruded onto sidewalk hip-high on left (house-ward) side of walk, and tripped over branch 1 on the ground on sidewalk. Saw garbage can on left side of walk when two feet away. Saw light pole (utility pole) two feet away.

Cane detected near curb (step-down), at Nash/Quigley intersection but unable to judge curb depth. Saw up-curb on opposite side of intersection four feet away. Street light illumination was brightest at this intersection when compared to the rest of the walking course.
Subject 1, walked course again with cane to which LED light was attached. Subject still under 20/800 reduced acuity simulation.
Saw bush 1 six feet away and did not contact the bush. Saw branch 1 on the ground on sidewalk from six feet away and did not trip on it. Saw blended near curb at intersection of Nash and Quigley from six feet away, reported better ability to perceive curb depth with supplemental lighting. Saw up-curb on opposite side of Nash/Quigley intersection ten feet away.

Subject 2, Walked course with no cane, no LED light: Overall, the Subject's stride length was shorter than under simulation conditions where light was present. Subject 2 also bumped into bush 1 and did not see branch 1 on the sidewalk. Subject could not see grass-sidewalk shoreline in dark areas (no street illumination). Saw near, drop-curb at Nash/Quigley intersection two to three strides away from curb. Saw far, up-curb at this intersection five strides away. No depth perception, could not discern curb depths. On the north side of the course, subject observed the silver hydrant within area of partial street illumination 5 strides away. Tree 1 next to sidewalk was seen 5 strides away. The subject saw No Parking sign (luminescent paint) 10 strides away.

Subject 2, Walked course with conventional orthopedic cane, no LED light: Subject was unable to see shrubs and other features at the edge of the sidewalk on the south side of the course. Subject saw near curb at Nash/Quigley intersection 13 strides away, however by this third time on the course subject commented that she was more familiar with the course and able to anticipate and look for some features such as the curbs at this intersection. Subject was able to see far, up-curb at 11 strides away. On north side of the course, saw hydrant at 3 strides, utility pole at 2 strides. Saw tree 1 at seven strides and “Home For Sale” sign at 2 strides. Saw tree 2 at four strides and No Parking sign at 12 strides. On the fourth leg of the course, crossing from the north to the south side of Nash St. to return to the course origin, an area that was dark and not illuminated by street lighting, Subject 2 saw the near, down-curb at 2 strides and the far, up-curb at 1 stride.

Subject 2, walked course again with cane to which LED light was attached, which was a prototype constructed in accordance with the present invention: During this course, subject did not comment on, nor was prompted to comment on, all of the obstacles reported during earlier courses. Subject was able to see shrubs on the south sidewalk two strides away. The subject did not see these shrubs when no light was present. Subject saw utility pole 1 7 strides away that she did not notice during the previous two courses in the absence of light. Subject saw near, down-curb at Nash/Quigley intersection 7 strides away, and far, up-curb 11 strides away. Subject saw tree 1 five strides away and Home For Sale sign five strides away. On the fourth leg of the course, crossing from the north to the south side of Nash St. to return to the course origin, an area that was dark and not illuminated by street lighting, no observation was recorded for the near, down-curb, however Subject 2 saw the far, up-curb 11 strides away.

### Example 3

In order to further demonstrate the advantages of the present invention by comparison with conventional mobility devices, to compare a mobility device produced in accordance with the present invention with a largely conventional device of the art, a test subject walked from the origin of the course described in Example 2 on South Nash St. for approximately 20 feet, using the commercially available PathLighter® cane (U.S. Pat. Nos. 6,463,947, 5,351,704) as the mobility device. The test subject reported that the lighted area provided by the PathLighter® cane covered approximately a 24 to 30 inch diameter around the circumference of the cane and, in contrast to the mobility devices of the present invention, provided no preview or perception of any objects beyond the diameter of this circle of light.

Thus, in the manufacture of a device according to the invention, shielding is essential to prevent upward and forward glare when in use. The shapes of such shielding may vary for support and mobility canes to accommodate differences in the geometries of how the canes are held by the user. For example, for a support cane such shielding may be perpendicular to the ground, for a mobility cane such shielding could be at approximately 50 degree angle to the ground. The shielding itself may be removably attached to the shaft of the cane itself, or permanently installed by conventional means.

The light means used and the switch means relative positions can be varied in embodiments of the invention. For example, when the light means and switch are offset on a mobility cane, the user's feet are illuminated. When the light means and switch are parallel, a shadow cast by the cane shaft is formed behind the cane and forms a dark, cone-shaped area that extends back so that the user's feet are unlit in the shadow. For example, some users have been found to be bothered by the shadow and desire it removed. It has been found that by offsetting the switch and the light slightly this issue can be rectified. Another, less preferable option, is to place a second lighting means at the back of the cane to shine on the area behind the cane. Or, one skilled in the art may appreciate that it may be possible to configure an array arrangement extending part or all the way around the cane to reduce or eliminate shadowing.

It is to be appreciated that based on the testing of users of experimental prototype support cane devices of the invention, it became apparent that a very preferred embodiment of such a device will be one that has a push-button switch in the handle, as an integral part of the battery holder, such as can be found in many conventional flashlights. This configuration advantageously enables the use of conventional batteries, such as AA batteries, in the metal tubing of the support cane and provides the concomitant and battery life of such batteries to the cane, and in addition reduces the production cost of the cane.

It is also to be appreciated that a significant distinguishing and differentiating aspect of the present invention from known conventional devices is that the light intensity is generally directed to be high near the feet of the user, so that the user can see, but is shielded above that level to avoid glare and blinding exposure to others at the intensities required to generate adequate amounts of light to enhance vision. This further has the advantage of avoiding problems with blinding light emanating from the device, such as would be produced by the use of a device as described in U.S. Pat. No. 7,784,479, which blinding effect is caused in the latter device by placing the illuminating LED in the angled portion of the cane as described therein, and further such a configuration would be difficult and expensive from a manufacturing perspective, by comparison with a can produced in accordance with the present invention.

Thus, in accordance with the invention, it has been found that the following configurations of a cane mobility device are particularly preferred:

White (and preferably LED) light is optimal as an illumination source.

Intensities of light are selected which are within ±20% of those described in FIGS. 1 and 2, in the positions described

The cane housing or shaft material, can be selected from aluminum, graphite or other conductive material, which is especially preferred to dissipate heat.

The housing can be hollow to accommodate internal batteries, wires, lights and circuit boards.

The switch for the illumination source can be positioned proximate to an end of the handle or be anywhere along the section of the housing, and can accommodate one or more intensities (e.g., high, low or high medium low).

Optionally, it is especially preferred that two or more LEDs can be used, for example in an array arrangement, to increase the radius and/or the intensity of the light beam. Different wavelengths if light can optionally be used.

Power is supplied by largely conventional AA, AAA or other suitable batteries, optimally in cane handle but optionally could be located below the LED in the upper portion of the cane shaft.

From the foregoing description of preferred embodiments of the invention, it will be readily understood by those skilled in the relevant art that the components of the embodiments as generally described and illustrated in the drawings herein, could be arranged and designed in a wide variety of different configurations. For example, the concepts and teachings of this present invention can be used in lighting for walkers and other personal mobility devices, wherein one or more shielded LEDs in single or array arrangement, can also be applied to ground-level lighting for walkers, wheelchairs and scooters, and such lighting can be optimally attachable, but optionally built-in to a forward-facing strut. The body of such a device would likely be similar to an LED headlamp, with batteries, LED, circuit boards and switch incorporated into a single unit, with one or more shielded LED lights pointed downward and outward to illuminate perhaps a 2-3 foot radius in front of user. Fastening means such as Velcro® or other adjustable material can be used in the assembly of the lighting means to the device. Optionally, anti-slip material at the interface of the device and the walker strut to hold the device in place and prevent it, during use, from slipping downward, can be employed.

Thus, as can be readily ascertained by one skilled in the art, the detailed description of the embodiments of the particular system described herein, and the components thereof and method of use of the present invention as described hereinabove and represented in the drawings, is not intended in any way to limit the scope of the invention, but is merely representative of the exemplary preferred embodiments of the invention. Therefore, while particular embodiments of the present invention have been disclosed, it is to be understood that various different embodiments are possible and are contemplated within the true spirit and scope of this invention. There is no intention, therefore, of imposing any limitations to the exact disclosure herein presented, and any such limitations are solely set forth in the appended claims.

What is claimed is:

1. A mobility enhancing device having means for electronically illuminating a travel path, which means comprises a housing, the housing containing an illumination source of an intensity range suitable for illumination of a travel path and of an optimal wavelength spectrum, the illumination being directed at such an angle downward and not forward, so as not to impair the vision of non-users of the device and to minimize glare from the illumination source that can interfere with the vision of the user.

2. The device of claim 1, wherein the illumination source is an electronically controlled LED light.

3. The device of claim 1, wherein the illumination source is positioned in a single segment of the device.

4. The device of claim 1, wherein the housing is collapsible.

5. The device of claim 1, wherein the device is selected from the group consisting of a long cane, a walking cane and a support cane.

6. The device of claim 2, wherein the LED light has a white color.

7. The device of claim 1, wherein the housing is selected from the group consisting of aluminum, graphite or other conductive material.

8. The device of claim 1, wherein the housing is substantially hollow.

9. The device of claim 1, wherein the housing comprises a switch for the illumination source positioned proximate to an end thereof and is operable to produce one or more intensities of illumination.

10. The device of claim 1, wherein power to the illumination source is supplied by largely conventional batteries located in the housing.

11. The device of claim 1, wherein power to the illumination source is supplied by largely conventional batteries located below the illumination source.

12. The device of claim 2, wherein the intensity of the LED illumination source is selected to be within ±20% of a preselected optimum intensity.
